(19) United States
(12) Patent Application Publication
(10) Pub. No.: US 2003/0188804 A1
(43) Pub. Date: Oct. 9, 2003

(54) Four-position machine carousel

(76) Inventor: Thomas F. Hill, Lawrenceville, GA (US)

Correspondence Address: MYERS & KAPLAN, INTELLECTUAL, PROPERTY LAW, L.L.C., 1827 POWERS FERRY ROAD, BUILDING 3, SUITE 200,, ATLANTA, GA, 30339, US

(21) Appl. No.: 10/118,842

(22) Filed: Apr. 9, 2002

(51) Int. Cl. B25H 1/00

(52) U.S. Cl. 144/286.5

(57) ABSTRACT

A multi-functional, rotational work bench device enabling a user to mount, store and utilize four power tools in a limited space, wherein a generally cube shaped machine carousel has a generally central rotational axis with four outer work surfaces, wherein the carousel can receive and secure at least one machine or power tool on each outer surface, wherein the rotational support members for the carousel are fully height adjustable, wherein a hand-crank and gear mechanism enables easy rotation of the carousel and wherein a locking mechanism secures selected rotational positions.

### TECHNICAL FIELD

The present invention relates generally to multi-functional work bench devices and, more specifically, to a four-position machine carousel enabling a user to mount, store and utilize four power tools in a limited space, wherein each piece of equipment is mounted on an individual surface of the carousel and selective rotation of the carousel to a desired position enables user access to a chosen tool and surrounding work surface.

### BACKGROUND OF THE INVENTION

Woodworking continues to be a popular hobby for many, notwithstanding the multitude of specialty tools required. Even those who focus their shop work on household repair and home renovation projects typically require multiple pieces of equipment such as sanders, drills, various saws including miter saws and scroll saws, and numerous hand tools including screw drivers and wrenches. Safe utilization and storage of even a common assortment of power tools necessitates free space.

Free surface space enables manipulation of workpieces and machines relative to one another. Surrounding free space is needed for complex or large projects and for storage of associated hand tools and accessories. Unfortunately, many do-it-yourselfers, wood working enthusiasts and craftsmen are relegated to limited work areas and often realize limitations in the diversity of their shop equipment due to spatial constraints.

Multi-purpose workbenches have been proposed that enable one surface to interchangeably mount a variety of machines or power tools, wherein a hobbyist could theoretically utilize one workbench as a support module for any one piece of equipment from an assortment thereof. In view of the present invention, however, such workbenches are disadvantageous because users are repeatedly faced with burdensome operational delays while they switch out equipment from a remote storage location to a workbench mount. Notwithstanding inefficient use of time, such dismounting and mounting of machines also may be prohibitively physically demanding for many individuals, considering that power saws, drills and the like are typically very heavy and unwieldy.

In attempts to avoid the limitations of multi-purpose workbenches with interchangeable mounts, workstations have been described wherein more than one tool or machine remains mounted thereto at all times. Such multi-tool workbenches are intended to enable a user to select between at least two different machines without a significant time loss. In view of the present invention, these multi-purpose workbenches are also disadvantageous.

Some multi-purpose workstations are dimensioned to receive and mount numerous tools thereon, wherein a selected tool is slidably moved across a large work surface to a user access position and a non-selected tool is slidably moved to a remote area of the work surface. While this type of design does prevent a user from having to lift and mount a machine for use because all of the machines remain mounted thereto at all times, the dimensions of such a vast work surface does little to alleviate potentially large spatial requirements.

Another type of multi-purpose workstation has a dual-work surface configuration, particularly wherein one type of saw is mounted on one side of a planar surface and another type of saw is mounted on the other side. If a user needs a table saw, he flips the planar surface so that the table saw is upright and the opposing machine is hanging upside down. This, too, is disadvantageous in view of the present invention. This dual-machine workstation is limited, by design, to two machines. Moreover, turning the mounting surface from one side to the other may also be too physically demanding for many individuals due to the weight and dimensional complexities of such saws.

Revolving workstations offering three work surfaces have been also been suggested, wherein a triangularly shaped center support retains tools mounted thereto. The triangular design that forms the basis of this type of device is disadvantageous in view of the present invention, wherein only three tools may be mounted thereon. Moreover, the available selection of tools that may be mounted on the available triangular workstations is further limited by height constraints that must be imposed on selected machines or power tools to allow for rotation of the three-sided, prismatic centerpiece.

Therefore, it is readily apparent that there is a need for a four-position machine carousel enabling a user to mount, store and utilize four power tools in a limited space, wherein each piece of equipment is mounted on an individual surface of the carousel, wherein the support frame is fully height adjustable to accommodate a variety of machine heights, and wherein selective rotation of the carousel to a desired position is mechanically assisted, thereby enabling quick and easy access to four mounted power tools of varying dimensions, thus preventing the above-discussed disadvantages.

### BRIEF SUMMARY OF THE INVENTION

Briefly described, in a preferred embodiment, the present invention overcomes the above-mentioned disadvantages and meets the recognized need for such a device by providing a four-position machine carousel enabling a user to mount, store and utilize four power tools in a limited space, wherein each piece of equipment is mounted on an individual surface of the carousel and selective rotation of the carousel to a desired position enables access to a chosen tool and surrounding work surface.

According to its major aspects and broadly stated, the present invention is a generally cube shaped machine carousel having a generally central rotational axis, wherein each of four outer surfaces of the carousel can receive and secure a machine or power tool thereon, wherein the rotational support members for the carousel are height adjustable, and wherein a hand-crank and locking gear mechanism enables easy rotation of the carousel and secure selection of rotational positions.

More specifically, the present invention in its preferred form is a multi-surface, rotational action workbench, wherein four generally square surfaces together define a generally cube shaped carousel with two substantially framed sides. At least one framed side preferably has at least one drawer and a central cross-support with a central rotation support point extending therefrom. A gear mechanism is provided with a handle, wherein rotation of the handle activates the gear mechanism and rotates the carousel, and wherein a locking mechanism is provided to restrict the gear mechanism and lock the carousel into position.

The carousel is supported by two upright members and diagonal cross-supports, wherein a power supply line is substantially contained within one of the upright members to prevent any limitations in carousel rotation. Each upright member also includes a pivot support mount capable of securely receiving a central rotation support point of the carousel, thereby supporting and enabling rotation of the carousel. Substantially unlimited height selectable and adjustable positions are available for each telescoping upright member, wherein the selected position and height is secured via an internal height adjustment mechanism. The mechanism is positioned within each upright member, wherein a centrally positioned, threaded member has an upper end that responds to rotation of a height selection arm via a cross-member, geared height adjustment rod. User rotation of the height selection arm initiates cooperative movement of each upright member via rotation of a generally internally carried support plate along the threaded member. A crank assisted mechanism enables adjustment of the height of the carousel supports, enabling accommodation of a variety of machine dimensions.

The two upright members are supported by a generally rectangular base frame. The base frame includes four casters, one positioned at each corner, to enable movement of the multi-surface, rotational action workbench, and two of the four casters are locking to enable fixed positioning thereof.

A feature and advantage of the present invention is the ability of such a device to provide storage and utilization of four pieces of equipment in a space typically required for one piece of equipment.

Another feature and advantage of the present invention is the ability of such a device to enable a user to quickly and easily change from one piece of equipment to another.

Another feature and advantage of the present invention is the ability of such a device to provide a work surface mount for machines and power tools of varying dimensions.

Another feature and advantage of the present invention is the ability of such a device to provide a gear-assisted means for rotation of a multi-surface workbench.

Another feature and advantage of the present invention is the ability of such a device to provide a multi-surface workbench with easily accessible on-board electrical power.

Another feature and advantage of the present invention is the ability of such a device to enable free rotation of a work surface without potential interference from electrical supply lines.

Another feature and advantage of the present invention is the ability of such a device to enable securely locked positioning of the four-surface carousel.

Another feature and advantage of the present invention is the ability of such a device to prevent tool and machine mounting limitations by enabling height and clearance selections.

Another feature and advantage of the present invention is the ability of such a device to enable selectively mobile relocation or fixed positioning of a multi-surface workbench.

Another feature and advantage of the present invention is the ability of such a device to enable mechanically assisted height adjustment for work surfaces.

These and other objects, features and advantages of the invention will become more apparent to one skilled in the art from the following description and claims when read in light of the accompanying drawings.

### BRIEF DESCRIPTION OF THE DRAWINGS

The present invention will be better understood by reading the detailed description of the preferred and alternate embodiments with reference to the accompanying drawing figures, in which like reference numerals denote similar structure and refer to like elements throughout, and in which:

FIG. 1 is a perspective view of a four-position machine carousel apparatus according to a preferred embodiment of the present invention, showing a device without tools or machines mounted thereon.

FIG. 2 is a partial, perspective view of the machine carousel apparatus of FIG. 1, showing a base and height adjustment mechanism therein.

FIG. 3 is a partial, cross-sectional view of the machine carousel apparatus of FIG. 1, showing the height adjustment mechanism thereof.

FIG. 4 is a partial, cross-sectional view of the machine carousel apparatus of FIG. 1, showing the carousel rotation mechanism thereof.

FIG. 5 is a partial, perspective view of a machine carousel apparatus showing a base and a height adjustment mechanism therein, according to an alternate embodiment of the present invention.

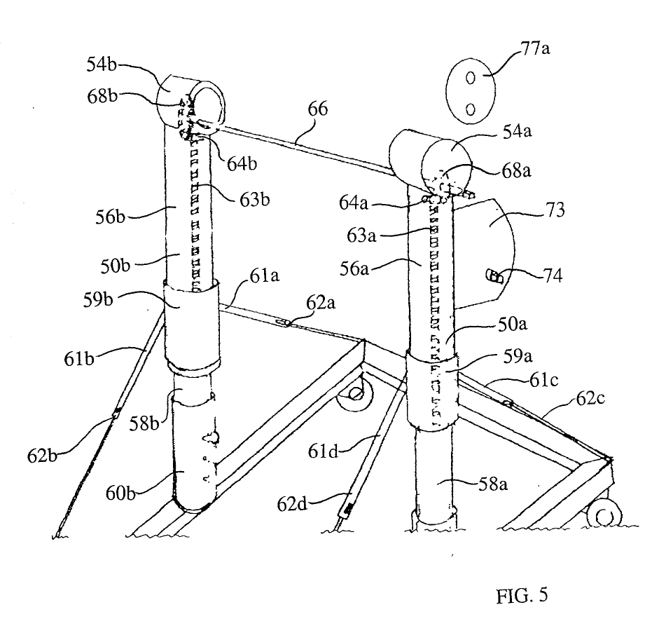

FIG. 6 is a non-perspective view of the machine carousel apparatus of FIG. 1, showing a carousel rotation locking gear mechanism.

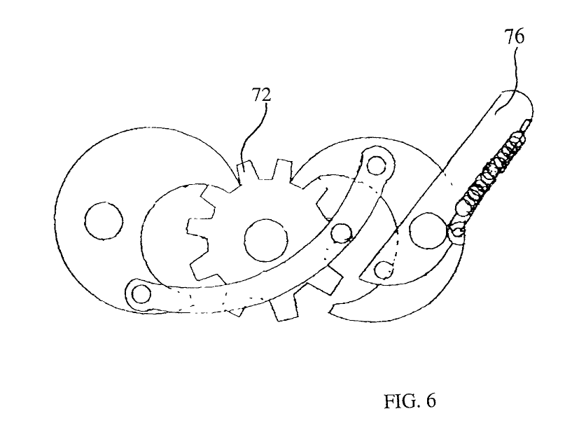

FIG. 7 is a perspective view of a four-position machine carousel apparatus according to an alternate embodiment of the present invention, showing a device without tools or machines mounted thereon.

FIG. 8 is a perspective view of the machine carousel apparatus of FIG. 7, showing the base and a partial view of a height-adjustment mechanism within the support arms, according to an alternate embodiment of the present invention.

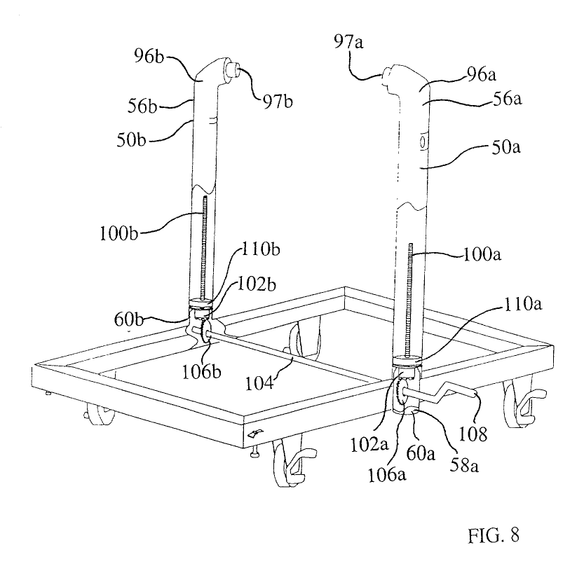

FIG. 9 is a perspective view of the machine carousel apparatus of FIG. 7, showing the carousel according to the alternate embodiment of the present invention.

FIG. 10 is a perspective view of a machine carousel apparatus, showing a base support according to an alternate embodiment of the present invention.

### DETAILED DESCRIPTION OF THE PREFERRED AND ALTERNATE EMBODIMENTS

In describing the preferred and alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

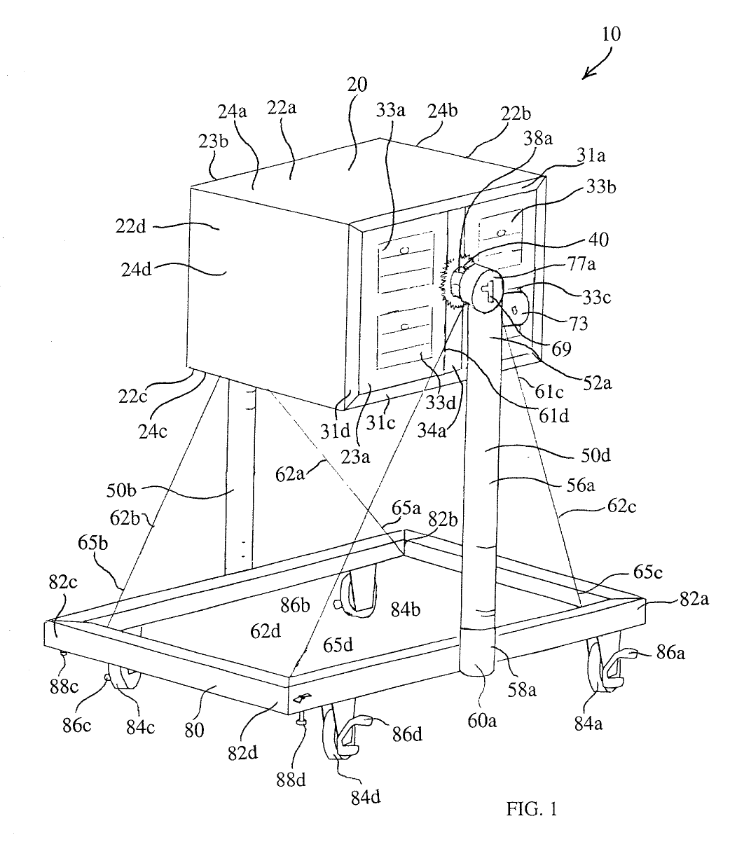

Referring now to FIG. 1, the present invention in its preferred form is a four-position machine carousel device 10, generally comprising carousel 20, upright supports 50a and 50b and base frame 80.

Preferably, carousel 20 is generally cube shaped, defined by four substantially flat work surfaces 22a, 22b, 22c and 22d and two sides 23a and 23b. Each work surface 22a, 22b, 22c and 22d preferably has a substantially square shape. While a square shape is preferred for work surfaces 22a, 22b, 22c and 22d and for sides 23a and 23b, wherein carousel 20 has a corresponding cube shape, other shapes could be utilized such as, for exemplary purposes only, a rectangular shape for work surfaces 22a, 22b, 22c and 22d, wherein carousel 20 could have a corresponding non-cubical, quadrilateral shape. Moreover, carousel 20 could have fewer than four work surfaces, resulting in a triangular or generally flat shape, or carousel 20 could have more than four work surfaces, wherein a pentagonal or other alternate shape could be defined.

Work surfaces 22a, 22b, 22c and 22d have outer surfaces 24a, 24b, 24c and 24d, respectively. Preferably, sides 23a and 23b are preferably secured to each work surface 22a, 22b, 22c and 22d, thereby preferably defining a substantially square frame shape having four frame members 31a, 31b, 31c, 31d and 32a, 32b, 32c, 32d (not shown) respectively, wherein frame members 31a and 32a are opposingly positioned on work surface 22a, frame members 31b and 32b are opposingly positioned on work surface 22b, frame members 31c and 32c are opposingly positioned on work surface 22c, and frame members 31d and 32d are opposingly positioned on work surface 22d. On e skilled in the art would readily recognize that sides 23a and 23b could alternately be integrally formed with work surfaces 22a, 22b, 22c and 22d, wherein a separate frame would not be utilized.

Preferably, side 23b provides access to drawers 33a, 33b, 33c and 33d, wherein each drawer 33a, 33b, 33c and 33d is configured to enable access to and retention of drawer contents irrespective of the rotational position of carousel 20. While access to drawers 33a, 33b, 33c and 33d is preferably provided via side 23b thereby minimizing potential interference from engageable wheel gear 40, first crank gear 72 and/or any other portion of the pivot and/or height adjustment controls, access to drawers 33a, 33b, 33c and 33d could be provided via side 23a, as shown in FIG. 1.

Cross-support 34a is preferably positioned at the midpoint of frame members 31a and 31c, wherein cross-support 34a extends therebetween. Cross-support 34a preferably has a generally rectangular shape. While a rectangular shape is preferred for cross-support 34a, alternative support configurations could be utilized such as, for exemplary purposes only, cylindrical shape or multiple supports forming an “X” or “+” shape support structure.

Preferably, cross-support 34b (not shown) is positioned at the midpoint of frame members 32a and 32c, wherein cross-support 34b extends therebetween. Cross-support 34b preferably has a generally rectangular shape. While a rectangular shape is preferred for cross-support 34b, alternative support configurations could be utilized such as, for exemplary purposes only, cylindrical shape or multiple supports forming an “X” or “+” shape support structure.

Preferably, each cross-support 34a and 34b defines central pivot mount 38a and 38b, respectively (38b not shown). Preferably, engageable wheel gear 40 is secured to cross-support 34a, wherein gear 40 is positioned proximate to central pivot mount 38a. Power cord 44 (not shown) is preferably positioned within upright support 50a, whereby passage through central pivot mount 38a enables a supply of power to carousel 20 and exit through cover plate 77a enables connection of power cord 44 to a power source. While it is preferred that cross-support 34a carry gear 40 and power cord 44, one skilled in the art would readily recognize that cross-support 34b could carry an alternative or supplementary gear or power cord.

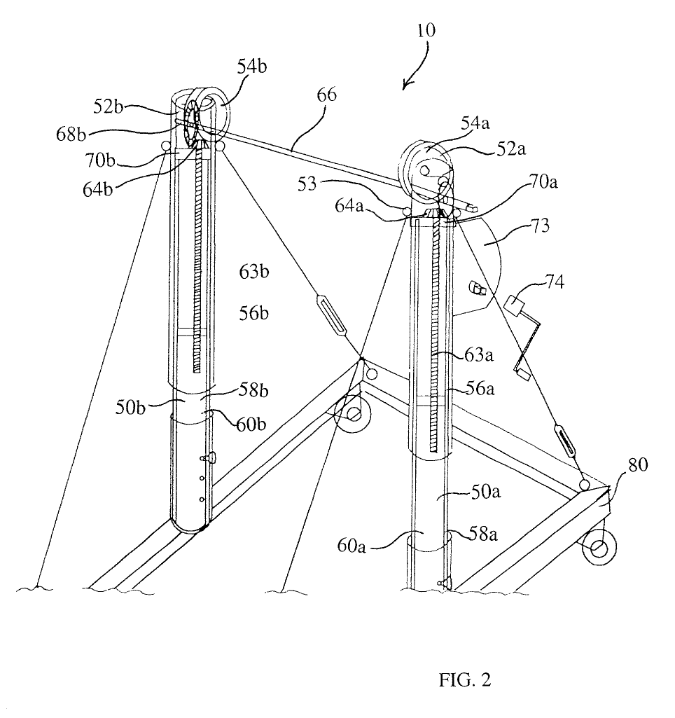

Carousel 20 is preferably supported between upright supports 50a and 50b (best seen in FIG. 2), wherein each upright support 50a and 50b is substantially hollow. Preferably, upper ends 52a and 52b of upright supports 50a and 50b, respectively, define pivot support mounts 54a and 54b, respectively, wherein pivot support mounts 54a and 54b are dimensioned to receive central pivot mounts 38a and 38b, respectively, enabling support and rotation of carousel 20 thereby and therewithin. Preferably, central pivot mounts 38a and 38b are not substantially elongated and do not pass through pivot support mounts 54a and 54b, 20 respectively, but reside therein. Preferably, cover plates 77a and 77b (77b not shown) are positioned on pivot support mounts 54a and 54b.

Preferably, the length of upright supports 50a and 50b is user-adjustable, wherein outer members 56a and 56b, respectively, define upper ends 52a and 52b, respectively, and inner members 58a and 58b of upright supports 50a and 50b, respectively, define lower ends 60a and 60b, respectively. Preferably, inner members 58a and 58b nest substantially inside of outer members 56a and 56b, respectively, thereby enabling a generally telescopic relationship therebetween.

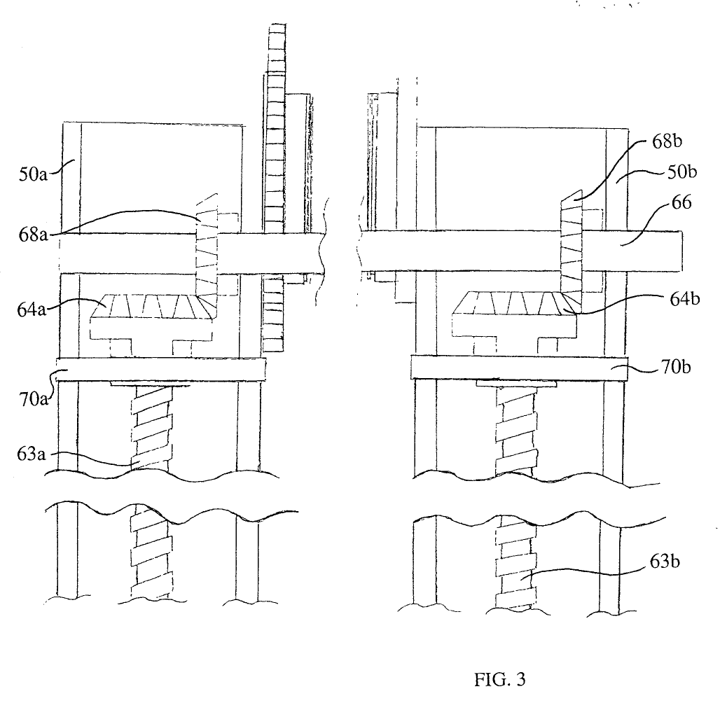

As best seen in FIG. 2 and FIG. 3, inner members 58a and 58b of upright supports 50a and 50b, respectively, preferably have elongated threaded members 63a and 63b, respectively, positioned centrally therein, wherein each threaded member 63a and 63b has engageable cap 64a and 64b, respectively, carried thereby. Preferably, a dual-gear height adjustment rod 66 extends between upright supports 50a and 50b, wherein height adjustment gears 68a and 68b are positioned to engage caps 64a and 64b, respectively. In response to rotation of handle 69 (seen in FIG. 1), distal plates 70a and 70b of inner members 58a and 58b, respectively, are urged along threaded members 63a and 63b, respectively, thus changing the height of upright members 50a and 50b.

Preferably, upright supports 50a and 50b are generally hollow, whereby power cord 44 (not shown) is positioned therein and fed therethrough, thereby enabling power cord 44 to extend from a power source, preferably through cover plate 77a of upright support 50a, passing through pivot support mount 54a and central pivot mount 38a into cross-support 34a. This preferred, generally internal positioning of power cord 44 enables free rotation of carousel 20 about pivot points 54a and 54b.

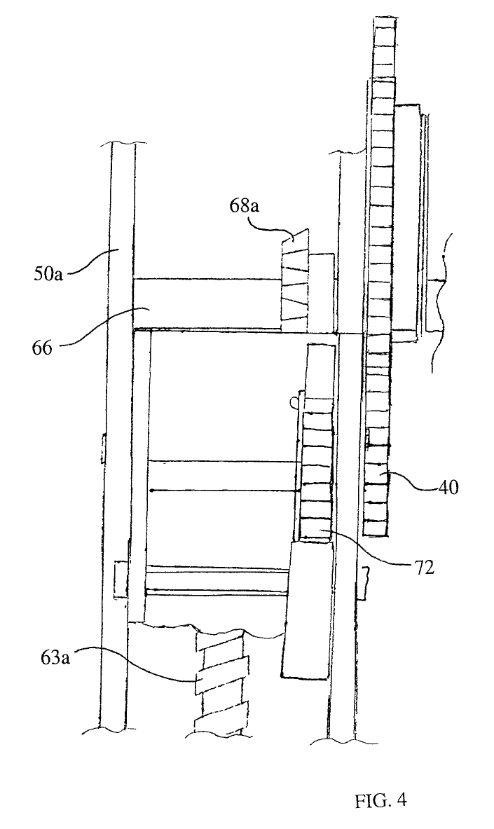

Preferably, first crank gear 72 (shown in FIG. 4) is positioned on crankplate 73 on upright support 50a in mechanical contact with engageable wheel gear 40. Crank knob 74 is preferably interchangeable with handle 69 and preferably removably extends from first crank gear 72 and crankplate 73 (best seen in FIG. 2), wherein a user can access and turn crank knob 74, thereby engaging wheel gear 40 and generating rotational movement of carousel 20 in either direction. Selection of a work surface 22a, 22b, 22c or 22d is secured via preferred spring latch mechanism 76, wherein a user can lock first crank gear 72 and prevent rotation thereof without necessitating utilization of a locking pin.

Preferably, upright supports 50a and 50b are mounted to base frame 80 and second ends 65a, 65b, 65c, and 65d of diagonal cross supports 62a, 62b, 62c and 62d, respectively, are secured to base frame 80, wherein first ends 61a, 61b, 61c and 61d of diagonal cross supports 62a, 62b, 62c and 62d are secured to upright supports 50a and 50b, preferably by a plurality of eyelets 53 (best seen in FIG. 2). While eyelets 53 are preferred, one skilled in the art would readily recognize that diagonal cross supports 62a, 62b, 62c and 62d could be secured to upright supports 50a and 50b by any means known in the art.

The weight of four-position machine carousel device 10 is preferably distributed across base frame 80 and supported thereby with assistance from diagonal cross supports 62a, 62b, 62c and 62d. Preferably, base frame 80 has a generally rectangular shape with four corners 82a, 82b, 82c and 82d. Although a rectangular shape is preferred for base frame 80, one skilled in the art would recognize that other frame shapes could be utilized such as, for exemplary purposes only, square or elliptical.

Preferably, base frame 80 includes casters, or wheels, 84a, 84b, 84c and 84d, wherein each caster 84a, 84b, 84c and 84d is positioned proximate to a corner 82a, 82b, 82c and 82d, respectively, to enable movement of the multi-surface, rotational action workbench of four-position machine carousel 10. Preferably, a locking mechanism 86a, 86b, 86c or 86d is provided for at least two of the four casters 84a, 84b, 84c or 84d, respectively, to enable fixed positioning of machine carousel 10.

Preferably, base frame 80 also includes leveling feet 88a, 88b, 88c and 88d (88a and 88b not shown), wherein adjustable extension of any or all feet 88a, 88b, 88c and/or 88d enables a user to compensate for a floor or support surface that is not level.

In an alternate embodiment, outer support rings 59a and 59b could be positioned proximate to upper ends 57a and 57b, respectively (57b not shown), to encircle upright supports 50a and 50b, respectively, in a relatively fixed position, wherein height adjustment of upright supports 50a and 50b generally would not affect the position of outer support rings 59a and 59b. Outer support ring 59b could carry first ends 61a and 61b of diagonal cross supports 62a and 62b, respectively, and outer support ring 59a could carry first ends 61c and 61d of diagonal cross supports 62c and 62d, respectively.

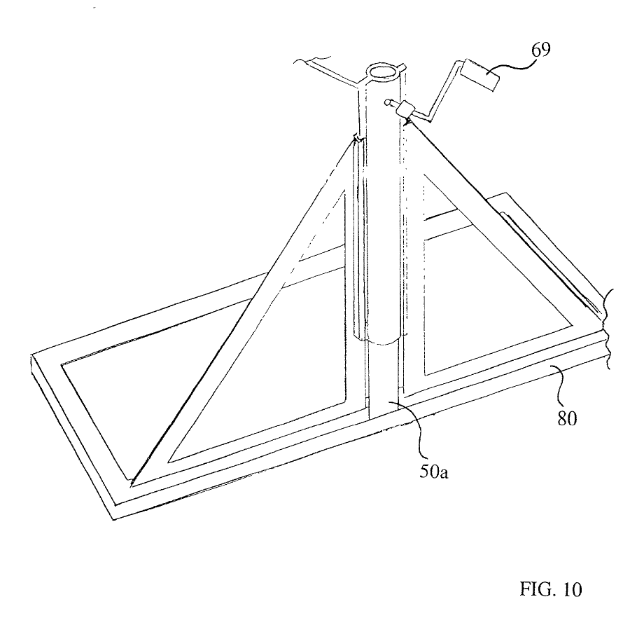

In an alternate embodiment, cross-supports 62a, 62b, 62c and 62c could be replaced with substantially rigid, generally triangular-shaped support members (as seen in FIG. 10), wherein each upright support 50a and 50b could have a support receptacle provided thereon or therein, whereby the triangular-shaped support members could be slidably retained therein, thereby enabling support without hindering height adjustability of supports 50a and 50b.

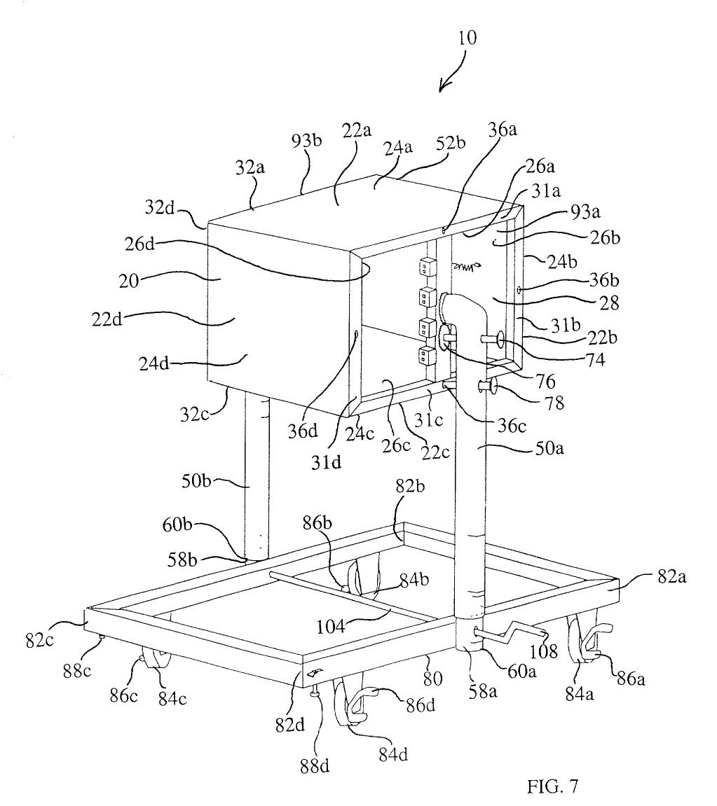

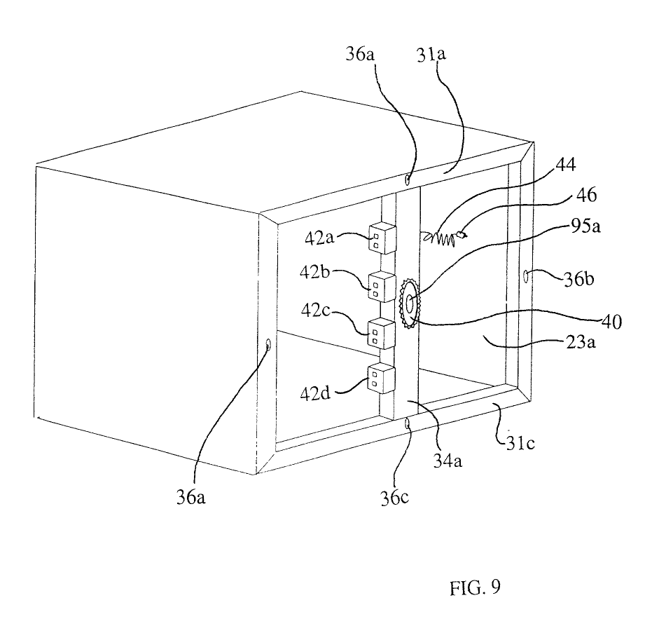

In an alternate embodiment, referring now to FIG. 7 and FIG. 9, carousel 20 could have two generally open side frames 93a and 93b. Inner surfaces 26a, 26b, 26c and 26d of work surfaces 22a, 22b, 22c and 22d, respectively, could define interior cavity 28 of carousel 20, wherein each generally open side frame 23a and 23b could enable user access to interior cavity 28. Each frame member 31a, 31b, 31c and 31d could define locking-pin receptacle 36a, 36b, 36c and 36d, respectively, wherein each locking-pin receptacle 36a, 36b, 36c and 36d could be positioned at the midpoint of the corresponding frame member, 31a, 31b, 31c and 31d, respectively. Frame members 32a, 32b, 32c and 32d could also define alternative or additional locking pin receptacles. Such alternative or additional locking pin receptacles could enable a user to utilize work surface 22a, 22b, 22c or 22d in a non-horizontal, or angled, position.

Each alternative cross-support 34a and 34b could define central pivot mount 95a and 95b, respectively (95b not shown). Electrical outlets 42a, 42b, 42c and 42d could be mounted on cross-support 34a, generally positioned within interior cavity 28. Any number of electrical outlets could be provided. Upper ends 96a and 96b of upright supports 50a and 50b, respectively, could define pivot points 97a and 97b, respectively, wherein pivot points 97a and 97b could be dimensioned to securely reside within central pivot mounts 95a and 95b, respectively, enabling support and rotation of carousel 20 thereby and thereabout. Pivot points 97a and 97b are not substantially elongated and do not pass through cross-supports 34a or 34b, but reside therein. However, one skilled in the art would readily recognize that pivot 20 points 97a and 97b could be elongated, passing into or through interior cavity 28.

In this alternate embodiment, the length of upright supports 50a and 50b is user-adjustable, wherein inner members 58a and 58b could have elongated threaded members 100a and 100b, respectively, positioned centrally therein, wherein each threaded member 100 a and 100b could have an engageable base 102a and 102b, respectively, carried thereby. A dual-gear height adjustment rod 104 could extend between base 102a and 102b of upright supports 50a and 50b, wherein height adjustment gears 106a and 106b could be positioned to engage bases 102a and 102b, respectively. In response to rotation of handle 108, height adjustment plates 110a and 100b could be urged along threaded members 100a and 100b, respectively, thus changing the height of upright members 50a and 50b.

Crank gear 76 could be positioned in mechanical contact with engageable wheel gear 40. Crank knob 74 could extend from crank gear 76 and upright support 50a, wherein a user could access and turn crank knob 74, thereby engaging wheel gear 40 and crank gear 76 and generating rotational movement of carousel 20 in either direction. Selection of a work surface 22a, 22b, 22c or 22d could be secured via passing preferably spring-loaded locking pin 78 through upright support 50a and positioning pin 78 within a locking pin receptacle 36a, 36b, 36c or 36d, respectively. Locking pin 78 could also be formed integrally with crank knob 74, thus providing a dual-function.

In an alternate embodiment, base frame 80 support four-position machine carousel device 10 without the use of diagonal cross supports.

In an alternate embodiment, base frame 80 could have a generally solid base support structure in lieu of an open frame structure and could be utilized without casters or wheels.

In an alternate embodiment, four-position machine carousel 10 could be assembled without base frame 80, wherein upright supports 50a and 50b could include independent base structures enabling direct floor placement and support thereof.

In an alternate embodiment, generally open side frames 23a and 23b could have doors generally covering the open space thereof, wherein items or materials placed within interior cavity 28 could be held therein.

In an alternate embodiment, outer surface 24a, 24b, 24c or 24d of at least one work surface 22a, 22b, 22c or 22d, respectively, could carry reference markings thereon for measurements or conversion data.

In an alternate embodiment, at least one inner surface 26a, 26b, 26c or 26d of at least one work surface 22a, 22b, 22c or 22d could carry pegboard or other means of mounting or holding tools or accessory parts thereon, such as removable containers and the like.

In an alternate embodiment, multiple cross-supports 34a could be provided for additional strength.

In an alternate embodiment, cross-supports 34a and 34b could be linked via a crosspiece extending through interior cavity 28.

In an alternate embodiment, upright supports 50a and 50b could be linked, wherein a substantially continuous support system could extend from the base of upright support 50a, through interior cavity 28, and down upright support 50b.

In an alternate embodiment, carousel 20 could be supported via only one upright support 50a or 50b, wherein a generally horizontal cross-support could extend therefrom forming a central support axis within carousel 20.

In an alternate embodiment, a motor could be provided within four-position machine carousel 10, wherein activation of gear 40 and rotation of carousel 20 could be driven thereby.

In an alternate embodiment, at least one work surface 22a, 22b, 22c or 22d could have a cord port provided therethrough to enable direct passage of an electrical cord from outer surface 24a, 24b, 24c or 24d to inner surface 26a, 26b, 26c or 26d, respectively.

In an alternate embodiment, uprights supports 50a and 50b could be substantially solid and/or could be directly surface mountable, such as to a floor or wall.

In an alternate embodiment, upright supports 50a and 50b could each have two parallel members with relative height adjustability in lieu of generally telescoping inner and outer members.

In an alternate embodiment, outer members 56a and 56b of upright supports 50a and 50b, respectively, could be rotationally mounted on inner members 58a and 58b, wherein by twisting outer members 56a and 56b relative to inner member 58a and 58b, the overall length of upright supports 50a and 50b increases, thereby increasing the clearance height of four-position machine carousel 10.

In an alternate embodiment, upright supports 50a and 50b could have an internal spring mechanism provided therein, wherein removal of a height adjustment knob could release a lengthening desire for upright supports 50a and 50b, or wherein twisting of a height adjustment knob could affect the length of upright supports 50a and 50b.

In an alternate embodiment, to enable access to an angled work surface, frame members 32a, 32b, 32c and/or 32d could include additional locking-pin receptacles, wherein locking pin 78 could secure carousel 20 in an angled position relative to base 80.

In an alternate embodiment, a different number of work surfaces could be included, wherein carousel 20 could be provide fewer than four work surfaces or greater than four surfaces, wherein carousel 20 could define a generally triangular shape or a pentagonal or hexagonal shape, respectively, or any other suitable shape capable of accommodating more than one tool or machine.

In use, a tool or machine is mounted to outer surfaces 24a, 24b, 24c and 24d of four-position machine carousel 10. Crank knob 74 is turned, causing rotation of carousel 20, thereby enabling user selection of a mounted tool or machine. Spring latch mechanism 76 is engaged to affix the selected work surface 22a, 22b, 22c or 22d into position. If height adjustment is desired, crank knob 74 can be moved and utilized as crank 69 and uprights supports 50a and 50b can be adjusted therewith. If a user desires to move four-position machine carousel 10 within a workroom, locking casters 84a, 84b, 84c and/or 84d are unlocked, movement is accomplished by rolling, and casters are again secured.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A rotational workbench device, comprising:
a central rotational axis;
a carousel having multiple work surfaces carried about said central rotational axis;
support means, wherein said support means carries said carousel and wherein said support means enables height adjustment of said rotational workbench device; and
locking means, wherein said locking means enables selection of one of said multiple work surfaces.

2. A machine carousel, comprising:
at least one elongated support member having a first end and a second end, said first end having a first pivot portion carried thereby;
a carousel unit having more than one work surface;
at least one brace carried by said carousel unit, said brace having a second pivot portion for said first pivot portion of said first end of said elongated support member, wherein said brace enables rotational movement of said carousel unit relative to said elongated support member; and
means for fixing position of said work surface.

3. The machine carousel of claim 2, further comprising a base frame.

4. The machine carousel of claim 2, wherein said multi-surface carousel unit is generally cube shaped.

5. The machine carousel of claim 2, wherein each said work surface of said more than one work surface carries a frame.

6. The machine carousel of claim 2, wherein said means for fixing position of said work surface is a locking mechanism comprising a tunnel defined through said at least one elongated support member, a locking port defined in at least one said work surface and a pin, wherein said pin is dimensioned to reside within said tunnel and said locking port.

7. The machine carousel of claim 2, further comprising a geared mechanism for rotation of said carousel unit.

8. The machine carousel of claim 7, wherein said means for fixing position of said work surface is a gear-securing latch.

9. The machine carousel of claim 2, further comprising at least one electrical outlet.

10. The machine carousel of claim 9, wherein said at least one electrical outlet is carried by said at least one brace and said at least one elongated support member directs a power source wire from said power source to said at least one brace.

11. The machine carousel of claim 2, wherein each said at least one elongated support member carries a height adjustment means.

12. The machine carousel of claim 11, wherein each said height adjustment means of each said at least one elongated support member comprises a first elongated outer support member portion; a second elongated inner support member portion, wherein said first elongated outer support member portion and said second elongated inner support member portion are telescopically related; an elongated, threaded member, said elongated, threaded member positioned generally within said second elongated inner support member portion, said elongated, threaded member having an engageable member, and a gear, said gear having a crank and said gear engaged with said engageable member of said elongated, threaded member, wherein movement of said crank rotationally engages said threaded member urging movement of one said elongated support member portion relative to the other elongated support member portion.

13. The machine carousel of claim 12, comprising two said elongated support members and one said crank, wherein a rod is positioned therebetween and wherein operation of said one crank activates each said gear of each said elongated support member.

14. The machine carousel of claim 7, wherein said geared mechanism comprises a wheel gear carried by said at least one brace proximate to said mount for said elongated support member and a geared hand control positioned proximate to and engaged with said wheel gear, wherein rotational movement of said geared hand control initiates rotational movement of said wheel gear and rotation of said carousel unit.

15. The machine carousel of claim 3, further comprising a plurality of wheels, wherein said plurality of wheels is carried by said base frame.

16. The machine carousel of claim 15, wherein at least one of said plurality of wheels has a selectable rotation prevention mechanism.

17. The machine carousel of claim 3, further comprising a plurality of leveling feet, wherein said plurality of feet is carried by said base frame.

18. The machine carousel of claim 4, further comprising at least one end surface, said at least one end surface substantially covering one end of said carousel unit.

19. The machine carousel of claim 2, wherein at least one work surface carries reference markings thereon.

20. The machine carousel of claim 2, further comprising at least one accessory receptacle.

21. The machine carousel of claim 7, wherein said geared mechanism comprises a wheel gear carried by said at least one brace proximate to said mount for said elongated support member and a motorized gear control positioned proximate to and engaged with said wheel gear, wherein rotational movement of said motorized gear control initiates rotational movement of said wheel gear and rotation of said carousel unit.

22. A rotating tool mount device, comprising:
a central rotational axis;
a carousel having at least one support arm and a plurality of work surfaces carried about said central rotational axis;
a plurality of elongated support members, wherein said plurality of elongated support members pivotably carry said carousel and wherein said plurality of elongated support members have adjustable length;
at least one lock for fixing rotational position of said carousel relative to said plurality of elongated support members;
a support base, wherein said support base carries said plurality of elongated support members;
a cog mechanism, wherein said cog mechanism enables rotation of said carousel;
at least one power connection member; and
a plurality of casters, said casters carried by said support base.

23. The rotational workbench device of claim 1, wherein said support means comprises a first upright support and a second upright support, each said upright support having a support carrier substantially fixedly positioned relative thereto, a plurality of support members, each said support member of said plurality of support members carried by a base, and wherein said locking means is a spring-loaded gear latch.

24. The method of storing and utilizing a plurality of bench tools comprising the steps of:
a. obtaining a workbench device having a plurality of work surfaces carried about a central rotational axis, wherein said workbench device is height adjustable;
b. mounting the plurality of bench tools on said plurality of work surfaces;
c. rotatably selecting one of said plurality of work surfaces;
d. utilizing the bench tool mounted on said one of said plurality of work surfaces;
e. rotatably de-selecting said one of said plurality of work surfaces and selecting a second said one of said plurality of work surfaces.
